(19) United States
(12) Patent Application Publication
(10) Pub. No.: US 2023/0272650 A1
(43) Pub. Date: Aug. 31, 2023

(54) COUNTERBALANCE SYSTEM FOR AN OVERHEAD DOOR

(71) Applicant: Zhide FENG, Northville, MI (US)

(72) Inventor: Zhide FENG, Northville, MI (US)

(21) Appl. No.: 17/681,165

(22) Filed: Feb. 25, 2022

(51) Int. Cl. E05D 13/00

(52) U.S. Cl. CPC E05D 13/1215; E05Y 2201/484; E05Y 2201/654; E05Y 2201/664; E05Y 2900/106; E05Y 2900/518

(57) ABSTRACT

A counterbalance system for balancing an overhead door installed against a structure of a vehicle or a house, the door having at least one door panel, the system has a longitude pipe with non-circular section cut; a pair of U-brackets having two side walls with one center hole on each side; a pair of torsion spring assemblies received within the pipe, and the inboard end of the assembly being slidingly engaged within the pipe; a pair of connecting shaft, with inboard side connected with the outboard end of each of the spring assemblies; the shaft passing through the center holes of the U-bracket; the outboard end of each shaft being fixed with the side wall on the outboard end of each of the U-brackets; a pair of drums each having a center hole received by the shaft, and each of the drums located between two side walls of the U-bracket.

### FIELD OF THE INVENTION

The present invention relates to a counterbalance system for balancing an overhead door installed with a frame structure of a vehicle trailer box, or a house, or for other similar applications.

### CROSS REFERENCE TO RELATED APPLICATIONS

This application claims priority and herein incorporates by reference U.S. provisional patent application 63/153,928, filed Feb. 25, 2021.

### BACKGROUND OF THE INVENTION

The invention relates to a counterbalance system of an overhead door with protection from the coercive and deteriorating effects caused by operating environments. The door spring assemblies within the counterbalance system rust quickly when left unprotected especially when they are equipped with a vehicle. Spring assemblies deteriorate and discharge accumulated rust and other foreign matter on vehicles as they pass underneath.

Continued exposure of a spring assembly to the surrounding environment decreases life expectancy, thereby, necessitating replacement. Long term exposure to environments such as this can cause the spring assembly to freeze up. This causes them to be non-functional.

Related arts regarding protective coverings for overhead door springs exist. These inventions generally include some kind of shroud disposed about a coiled spring. These devices also function as safety features in the event the coiled spring breaks.

There have been several technologies trying to resolve above issues, some of which are illustrated by US patents of U.S. Pat. Nos. 5,671,500, 4,601,131, and 4,783,929.

U.S. Pat. No. 5,671,500 makes use of an extendable tubular cover to seal a coil spring within.

Some of its shortcomings are: 1) It is hard to install said cover and have both its two extendable halves fully fixed; 2) The wearing and noise are hard to overcome especially when it has been used for a long time.

Therefore, a more convenient, reliable and cost effective technology is still needed for overcoming these issues.

### SUMMARY OF THE INVENTION

Other features and advantages of the instant invention will become apparent from the following description of the invention which refers to the accompanying drawings.

### BRIEF DESCRIPTION OF THE DRAWINGS

FIG. 1 shows isometric view of the preferred embodiment of the present invention, a counterbalance system for an overhead door;

FIG. 2 shows the counterbalance sub system with the pipe sectional cut for showing the spring assembly inside;

FIG. 3 shows the first end of the counterbalance system;

FIG. 4 shows the first end of the counterbalance system with a section cut along the Y coordinate;

FIG. 5 shows the first end of the counterbalance system with a section cut along the Y coordinate, but with cutting plane with different orientation;

FIG. 6 shows the second end of the spring assembly within the pipe in an aerial view;

FIG. 7 shows the first rotary assembly;

FIG. 8 shows the second rotary assembly with an section-cut view;

FIG. 9 shows the first end of the spring assembly;

FIG. 10 shows how a side view of the first end of the counterbalance system with the pipe hidden;

FIG. 11 shows the first end of the counterbalance system with a section cut along the Y coordinate;

FIG. 12 shows the whole view of the spring assembly;

FIG. 13 shows the first end of the spring assembly with a section cut;

FIG. 14 shows the second end of the spring assembly;

FIG. 15 illustrates the first rotary assembly with a section cut;

FIG. 16 illustrates the second embodiment of this invention;

FIG. 17 shows the first end of the second embodiment.

FIG. 18 shows the isometric view of the coupler;

FIG. 19 shows the coupler with a section cut;

FIG. 20 shows the second embodiment when the pipe is section cut;

FIG. 21 shows the first end of the second embodiment with a section cut;

FIG. 22 shows an isometric view of the collar;

FIG. 23 shows the a section cut view to show the stationary cone within the pipe;

FIG. 24 shows an isometric view of the of the shaft end holder;

FIG. 25 shows an isometric view of the U-bracket;

FIG. 26 shows an isometric view of the of the winding cone;

FIG. 27 shows an inboard end of the spring assembly;

FIG. 28 shows an outboard end of the spring assembly;

FIG. 29 shows the status of the counterbalance sub assembly with the pipe with a section cut;

FIG. 30 is an isometric view of the third embodiment of the present invention when applied to a dual car garage door of a house;

FIG. 31 shows the counterbalance sub system of the third embodiment of the present invention, when said sub system is mounted on the first end of a garage door;

FIG. 32 shows the first half of the third embodiment of the present invention, which is mounted on the first end of a garage door.

### DETAILED DESCRIPTION OF THE INVENTION

As introduced at U.S. patent Ser. No. 10/260,264 B2, there are two types of counterbalance systems for overhead doors: dead axle type and live axle type.

After being installed, the dead axle type has an axle, or shaft which is stationary with respect to the house or the vehicle with which the counterbalance system is installed. In the contrary, the live axle type has an axle, or shaft rotating together with the drums/plugs.

The preferred embodiment of the present invention is for a counterbalance system of live axle type.

For interpretation of the preferred embodiment of the present invention, a counterbalance system 10, a Cartesian coordinate system X-Y-Z is established as shown at FIG. 1 and FIG. 3. When counterbalance system 10 is usually installed at the upper rear corner of a trailer box of a vehicle, the X coordinate of said coordinate stands for rearward direction, Y for curb-facing direction (in USA), and Z for upward direction of a vehicle.

In following description, counterbalance system 10 and all its parts and all other parts related to the door have a first end on the curb side (left at FIG. 1), and a second end on the road-center side (right at FIG. 1) for American vehicles.

For easier description for the assembling and installation, the concepts of outboard end and an inboard end for most parts and sub-assemblies are also utilized thereafter.

Counterbalance system 10 has an octagon pipe 20 in the middle and being longitude-wise in +/−Y direction, a first rotary assembly 30 on the first end, and a second rotary assembly 30′ on the second end. Counterbalance system 10 also has a spring assembly 70 received within octagon pipe 20, and a pair of media brackets 85 and 85′ (FIGS. 1, 2, and 3). Octagon pipe 20 has a longitude octagon through hole 21 with a center line in Y direction, and has lateral holes 22 at each of its ends.

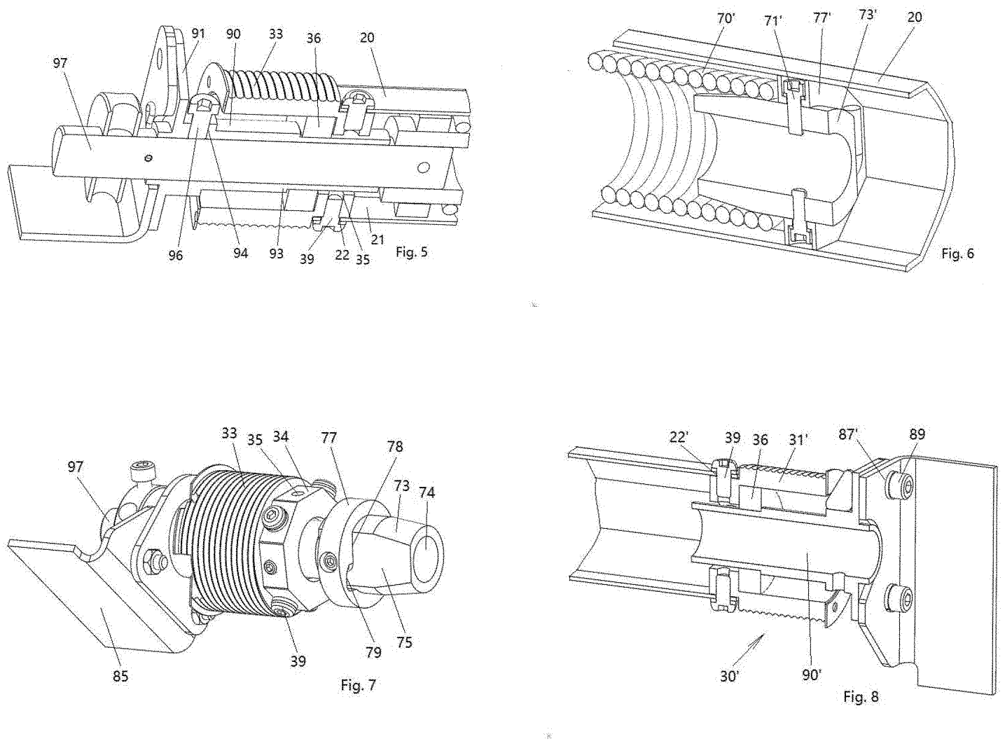

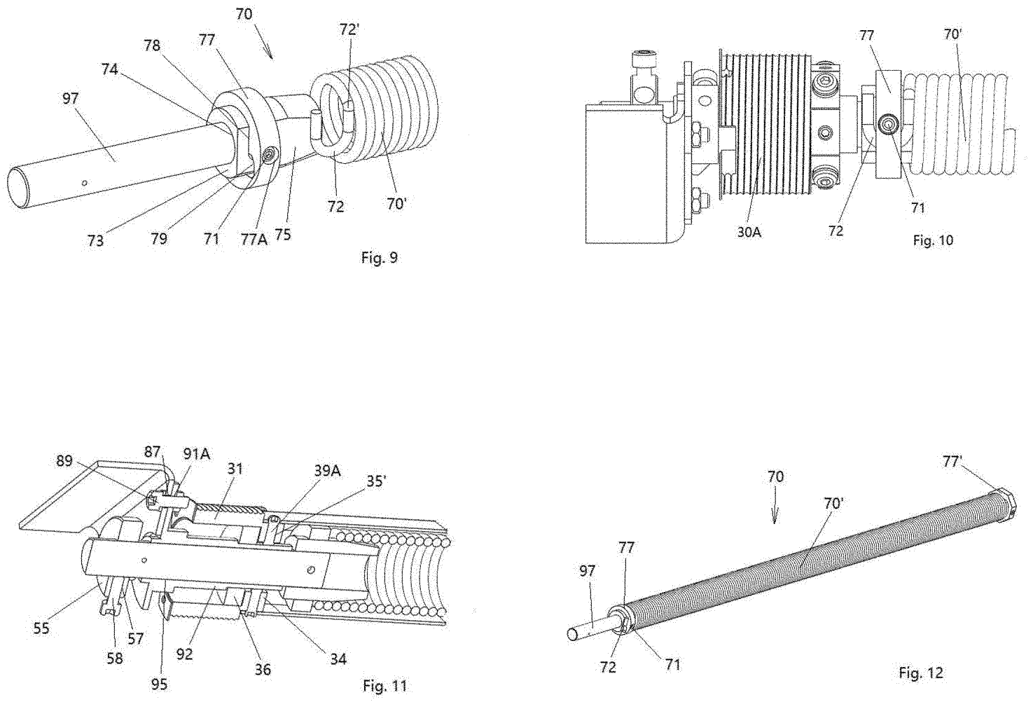

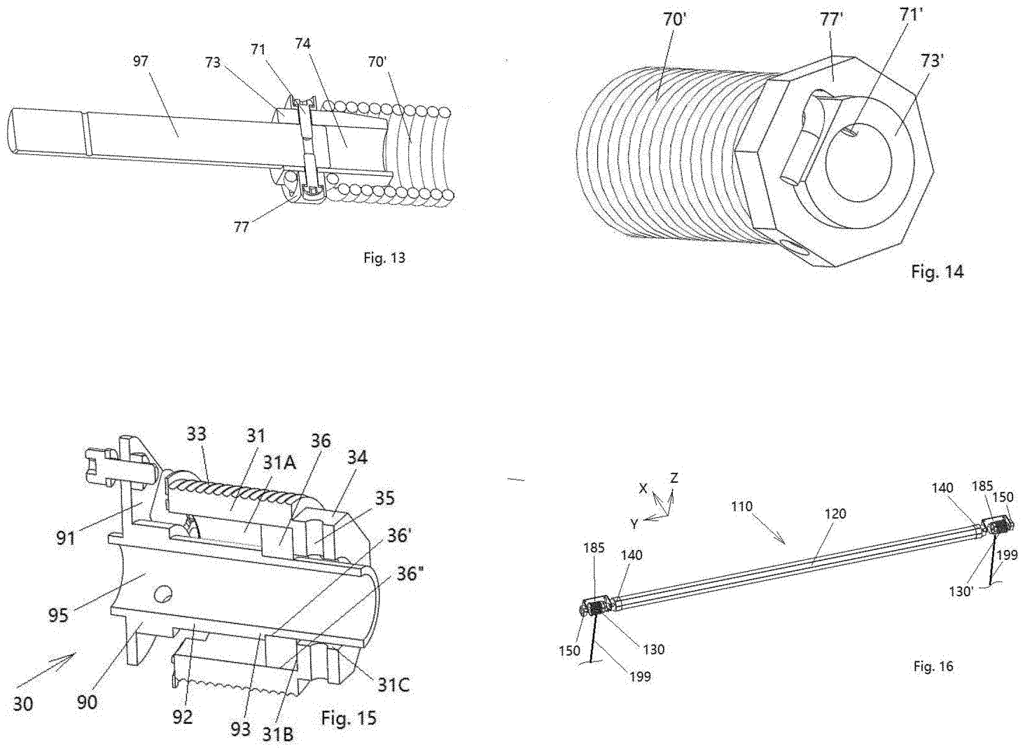

As shown at FIG. 9 and FIG. 13, spring assembly 70 has a torsion spring 70′ having a U-shaped portion 72 at each end of torsion spring 70′. The plane of U-shaped portion 72 is parallel to the Y coordinate, or the center line of torsion spring 70′. U-shaped portion 72 can also has an extra kink 72′ to let U-shaped portion 72 be rested on the flat area 75 of the first cone 73 (also FIG. 7). First cone 73 has a circular longitude hole 74 whose center line is collinear with that of torsion spring 70′ matching a connecting shaft 97.

A first collar 77 has a circular exterior contour and a basically circular hole internally, except a flat area 78 for matching flat area 75. A recession 79 is further cut at flat area 78 to hold U-shaped portion 72 firmly (also FIG. 10). At least one lateral hole 77A is cut at first collar 77 (FIG. 9), At least one screw 71 passes lateral hole 77A then passes through a lateral hole 73A on first cone 73, then engaged with a threaded lateral hole 98 on inboard end of connecting shaft 97 (FIG. 4).

As shown at FIG. 6 and FIG. 14, on its second end, the second end of torsion spring 70′ is engaged with the first end of a second cone 73′ and it is further secured by a second collar 77′ through a screw 71′ in a similar way as that of first collar 77 fixed to first cone 73, but the external shape of second collar 77′ needs to be octagon, or in other non-circular shape for matching the internal shape of octagon pipe 20. Therefore, second collar 77′ and the second end of torsion spring 70′ must be turned together, or stay still together with octagon pipe 20, but second collar 77′ and the second end of spring assembly 70 can be moved laterally along Y coordinate with respect to octagon pipe 20.

FIG. 12 shows the appearance of spring assembly 70 as a whole assembly.

FIG. 15 shows how first rotary assembly 30 itself is assembled. First rotary assembly 30 has a first drum 31, a first pivotal bracket 90, and a bearing 36 which is optional.

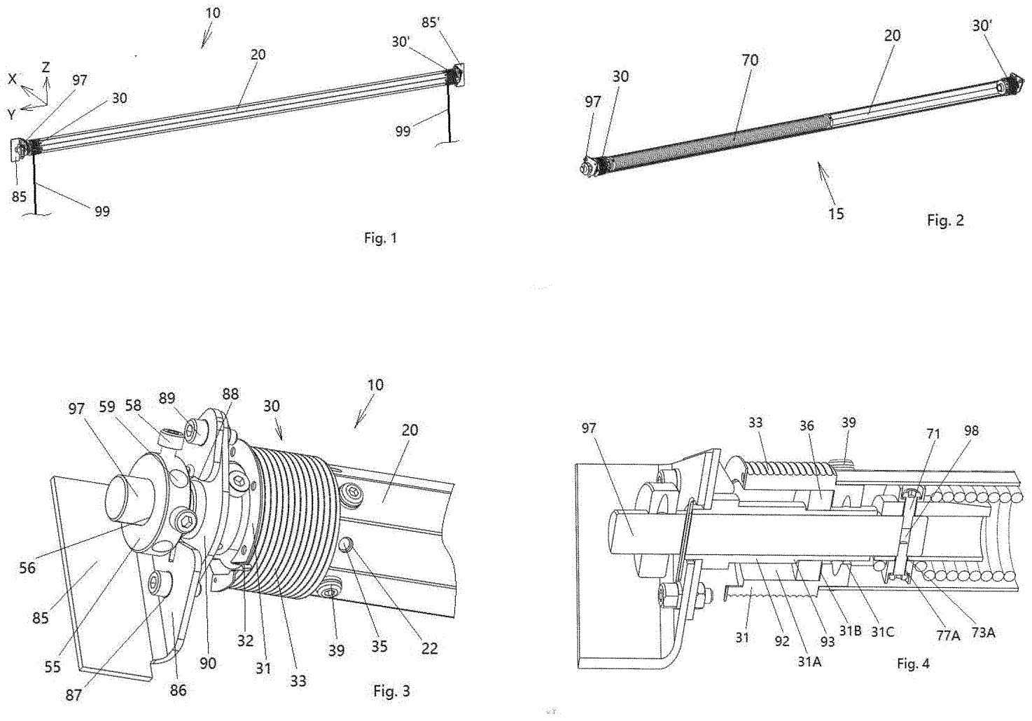

First drum 31 has a cup shape structure, whose outboard end has a circular internal surface 31A, an internal bottom surface 31B, and a hole 31C passing through the bottom. The external surface of first drum 31 is basically also circular, which is cut with a spiral groove 33 for guidance and reeling of a cable 99 (FIG. 2). At its second end, first drum 31 has a bottom portion with an octagon-shaped external edge 34, which is engaged with the first end of internal surface of octagon pipe 20. Said octagon-shaped external edge 34 also has some threaded holes 35 whose center line is normal to the center line of first drum 31 (FIG. 5).

First drum 31 also has an engagement slot 32 at the edge of its outboard end for receiving and holding a first end fitting 99A (not shown) of cable 99 (FIG. 2, FIG. 3).

As shown at FIG. 5 and FIG. 15, said 90 has two basic portions: a base portion 91 which can be a flat plate, and a tubular portion 92 with a longitude through hole 95. Said 92 has a shoulder portion 93. The internal surface 36′ of a bearing 36 is press-fitted with the external surface of said 92, while the external surface 36″ of said bearing 36 is press-fitted with the internal surface 31A of first drum 31 until bearing 36 abuts bottom surface 31B on one side and abuts shoulder portion 93 on the other side. With above setting, first drum 31 can be turned in +/−Y direction (right-hand rule) freely with respect to 90, but generally can not be slid translation-wise easily along +/−Y direction.

Then the first end of connecting shaft 97 in conjunction with other parts of spring assembly 70 is inserted along +Y direction to the second end of longitude through hole 95 of said 92 then pashed fully through longitude through hole 95 (FIG. 4), then a screw 96 is engaged with a threaded hole 94 on said 92 to fix connecting shaft 97 and 90 together (FIG. 5). At this time, the first end of connecting shaft 97 stays outside longitude through hole 95.

Then starting from its second end, the whole length of spring assembly 70 is inserted in −Y direction into the first end of octagon pipe 20, until said octagon-shaped external edge 34, or the second end of first rotary assembly 30 is received within the first end of octagon pipe 20, with its octagon-shaped external edge of 34 matching and being engaged with internal octagon shaped surface of octagon pipe 20, and then the first end of octagon pipe 20 is ready to be connected with first drum 31.

A screw 39 passes through lateral hole 22, and then engaged with threaded hole 35 (FIG. 5), leading to octagon pipe 20 and first drum 31 is then bound together. In this engagement, the bottom of screw 39 should not touch the external surface of said 92, which allows octagon pipe 20 together with first drum 31 having freedom to turn in +/−Y direction with respect to connecting shaft 97 and 90 (FIG. 5).

As shown at FIG. 8, second rotary assembly 30′ is basically symmetrical to 30. Second rotary assembly 30′ has a second drum 31′ (symmetrical to first drum 31), a second pivotal bracket 90′ (symmetrical to 90), and a bearing 36.

Then the inboard end of second rotary assembly 30′ is inserted along +Y direction into the second end of octagon pipe 20, until the octagon-shaped external edge of 34′ of first drum 31 matching and being engaged with internal octagon shaped surface of octagon pipe 20, and then the second end of octagon pipe 20 is fully fixed with second drum 31′ by screws 39.

Different from its first end, the second end of counterbalance system 10 does not have to have a shaft similar to connecting shaft 97, since that the first end is an active end for providing torque to octagon pipe 20. The existence of connecting shaft 97 makes the installation between spring assembly 70 and 30 much easier, and the winding operation of spring assembly 70 much easier too, which will be explained soon.

In the contrary, second rotary assembly 30′, or the second end of counterbalance system 10 is a passive end. Second pivotal bracket 90′ just needs only to hold second drum 31′ pivotally and to accept torque from spring assembly 70 through 20.

As shown at FIG. 3 and FIG. 11, a collar 55 having a first hole 56 is engaged with the first end of connecting shaft 97 and is tightened by a screw 58 to a threaded hole 57 on collar 55. Collar 55 also has usually several winding holes 59 whose center line is normal to the center line of connecting shaft 97.

Then a counterbalance sub system 15 is ready to be installed with media bracket 85 and 85′. With octagon pipe 20 partially hidden, the configuration of counterbalance sub system 15 is shown at FIG. 2.

Media bracket 85 has a vertical portion, or side wall 86 having holes 87 and a central recessed opening 88, and it is welded at the first rear up corner of said trailer box of said vehicle and has an orientation as shown at FIG. 1 and FIG. 3, while media bracket 85′ is symmetrical to media bracket 85, and it is welded at the second rear up corner of the trailer box.

Then counterbalance sub system 15 is placed at the rear up corner and between media bracket 85 and 85′ in the trailer box, as shown at FIG. 1.

Then screws 89 pass through hole 87 and hole 91A to fix first pivotal bracket 90 and media bracket 85 together (FIG. 3).

90′ is fixed with 85′ by another screw 89 in the similar but symmetrical way also.

As shown at FIG. 5 and FIG. 10, at this point, screw 96 is then released,

Then the second end fitting 99B of cable 99 is connected with a bottom location of said panel (not shown) of the door (not shown), and the first end fitting 99A is connected with engagement slot 32 (32′) of first drum 31 (second drum 31′), then first drum 31 and second drum 31′ together with octagon pipe 20 is turned in −Y direction for reeling in the cable 99 to overcome the slack until a slight torque is felt.

With first drum 31 (second drum 31′) is held stationary by cable 99, then a winding bar (not shown) is inserted to winding hole 59 to wind connecting shaft 97 and the first end (outboard end) of 70 in −Y direction further to an appropriate amount for creating appropriate torque for balancing the door, then screw 96 is tightened again. Appropriate torque usually means ideally counterbalance system 10 can balance said door at any height wherever it is driven by an external force (either by a human hand, or a motor, or other means).

Then counterbalance system 10 is operable now. In other words, when said door is lift upward, counterbalance system 10 releases its energy for helping lift the door. While in the contrary, said spring of counterbalance system 10 is stored with energy when said door is pushed down.

Optionally, for mitigate the hard work of winding the spring in a tight space, spring assembly 70 can be wound to create torque energy to counterbalance system 10 first at a bench table, or an open place. This process follows:

Just after 30 is connected together with 70 and octagon pipe 20 by screw 39, octagon pipe 20 is held and fixed by a V-clamp, then a winding bar is inserted to winding hole 59 (FIG. 3). With help of the winding bar, connecting shaft 97 is wound in −Y direction to a pre-calculated amount, then a set screw 39A is engaged with 35′ until it is pressed against tubular portion 92 (FIG. 11), and screw 96 is made sure to be tightened to pressed against connecting shaft 97 (FIG. 5), at this point, before cable 99 plays its role, the stored torque energy of counterbalance system 10 is temporarily locked by its own, through the help of set screw 39.

The difference between set screw 39A and screw 39 is that screw 39 binds octagon pipe 20 and first drum 31 together only, while set screw 39A can adjustably bind first drum 31 and tubular portion 92 of first pivotal bracket 90 together.

Then above setting is placed to working location and connected with media bracket 85 and 85′ as shown above, then second end fitting 99B of the cable 99 is connected with the bottom panel and first end fitting 99A is connected with engagement slot 32 (32′), then set screw 39A is released, then the door is subjected to lifting effort of the spring. If necessary, counterbalance system 10 can be fine-tuned subsequently by losing screw 96 first, then inserting said winding bar to winding hole 59, then turning connecting shaft 97 in either +Y or −Y direction, then tightening screw 96 again.

Above setting is also helpful for maintenance. For instance, if the bottom panel is broken after an overhead door has been used for a period of time, usually these three basic operations are needed for an overhead door with conventional technology: 1) unwinding the spring to release all its torque energy first; 2) unhooking cables from the panel; 3) then replacing the bottom panel; 4) hooking back the bottom end of the cable to the panel; 5) then winding back the spring to store torque energy again.

In the contrary, with the present invention, counterbalance system 10, step 1 and step 5 above can be saved, or omitted.

For replacing a bottom panel for an overhead door with counterbalance system 10 of the present invention, only set screw 39A needs to be tightened, then the torque energy is stored at its own within counterbalance system 10, then said second end fitting 99B of cable 99 is disconnected from the bottom panel.

After replacing the panel, second end fitting 99B is connected to the repaired/new panel again, and then set screw 39 is released, or disconnected from 35′ of first drum 31, then the door is subjected to lifting load again created by the torque of the spring.

It is worthy to notice that, even though said octagon pipe 20 can protect said spring assembly 70 against dust and water by keeping spring assembly 70 inside its longitude through holes, its more important function is bridging, or first drum 31 and the movable end (second end for this case) of said spring. This means that this pipe is actually an external through shaft playing same function of a conventional shaft which is received within a spring assembly of a conventional overhead door for either a truck or a house.

When being installed with an overhead door for a house, media bracket 85 (85′) may have different shape and it is usually connected to the frame structure of the house by fasteners, but not by welding.

### Other Embodiments

The second embodiment of a counterbalance system 110 is shown at FIG. 16.

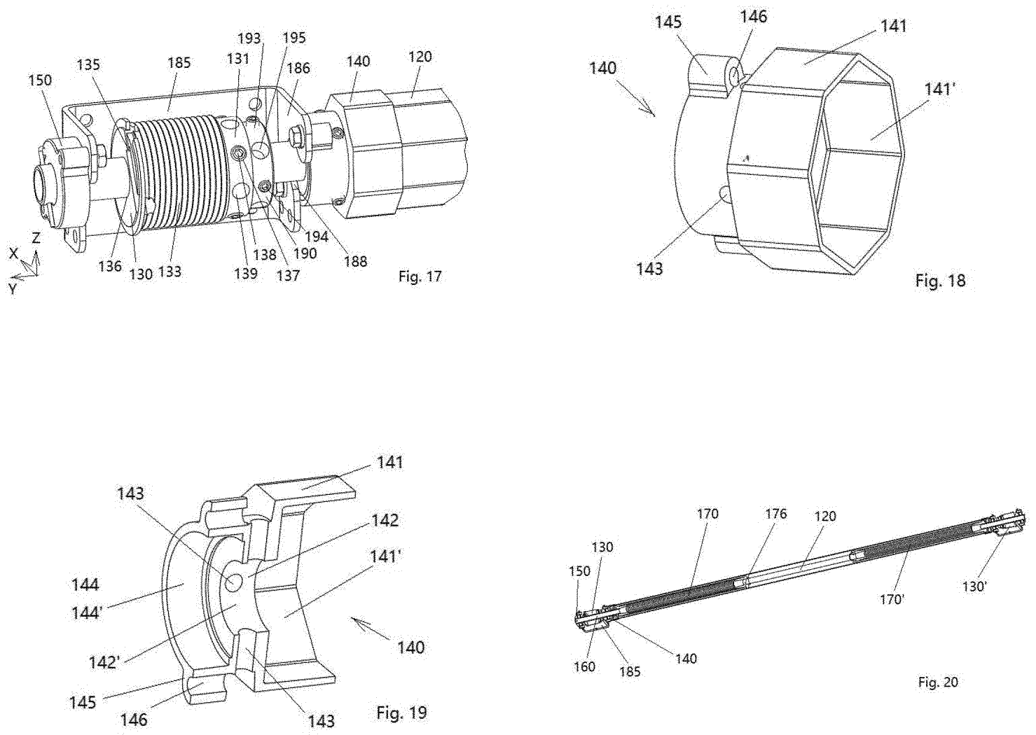

Again, a Cartesian coordinate system X-Y-Z is established as shown at FIG. 16 and FIG. 17. The orientation of this coordinate keeps the same as that in the preferred embodiment.

Counterbalance system 110 has an octagon pipe octagon pipe 120, two couplers 140, a first spring assembly 170 and a second spring assembly 170′ (FIG. 20), two connecting shafts 160, two U-brackets 185, two shaft end holders 150, a first plug 130, and a second plug 130′.

Usually one U-bracket 185 is welded at the curb side rear up corner of a truck box and another U-bracket 185 welded at the road side rear up corner of a vehicle box. As shown at FIG. 25, usually U-bracket 185 has two vertical portions, or side walls 186, each of which has a recessed opening 188, and at least one through hole 187.

Refer to FIG. 28, a winding cone 172 has a center hole 173, a cone shaped external surface 174 with which the winding end of a torsion spring 171 is engaged. Connecting shaft 160 is received within center hole 173. Winding cone 172 also has at least one threaded hole 175 whose center line is normal to Y coordinate. A set screw 179 is engaged with threaded hole 175 to fix connecting shaft 160 together with winding cone 172. Refer to FIG. 27, the stationary end of the torsion spring 171 is fixed with a cone shaped external surface 178 of a stationary cone 176, which has an octagon flange 177.

Then the first spring assembly 170 is ready for further installation.

FIG. 18 and FIG. 19 show coupler 140. Coupler 140 usually has three portions: an octagon-shaped cup portion 141 with an octagon internal surface 141′ and open end on its inboard side, a circular-shaped cup portion 144 with an internal circular surface 144′ and an open end on its outboard side. Octagon-shaped cup portion 141 and circular-shaped cup portion 144 is connected together by a media portion 142 which has a center hole 142′. Media portion 142 also has at least one thread hole 143 whose center line in normal to Y coordinate. Circular-shaped cup portion 144 also has usually two annex ears 145 each having threaded holes 146 whose center lines are parallel to Y coordinate. Coupler 140 has basically a center line passing through all three portions mentioned above, and it is collinear with the center line of octagon pipe 120 and connecting shaft 160.

As shown at FIG. 17, first plug 130 has a center through hole 136 whose center line is collinear with that of connecting shaft 160 and coupler 140. Its external surface is basically circular, which is cut with a spiral groove 133 for guidance and reeling of a cable 199 (FIG. 16). At its inboard end, first plug 130 has at least one thread hole 137, and at least one winding hole 139, both of whose center lines are normal to the center line of first plug 130. First plug 130 also has an engagement slot 135.

As shown at FIG. 17 and FIG. 22, a collar 190 has a center hole 192 whose center line is collinear with that of connecting shaft 160. Collar 190 has at least one threaded hole 193, and at least one winding hole 195, both of whose center lines are normal to the center line of collar 190.

Refer to FIG. 24, shaft end holder 150 is similar to circular-shaped cup portion 144 of coupler 140. It has a circular-shaped cup portion 151 with an internal circular surface 151′ and an open end on its inboard side. On its bottom, it has a through hole 153. Both center lines of internal circular surface 151′ and through hole 153 is collinear to the center line of connecting shaft 160.

Shaft end holder 150 also has usually two annex ears 152 each having threaded holes 154 whose center lines are parallel to Y coordinate.

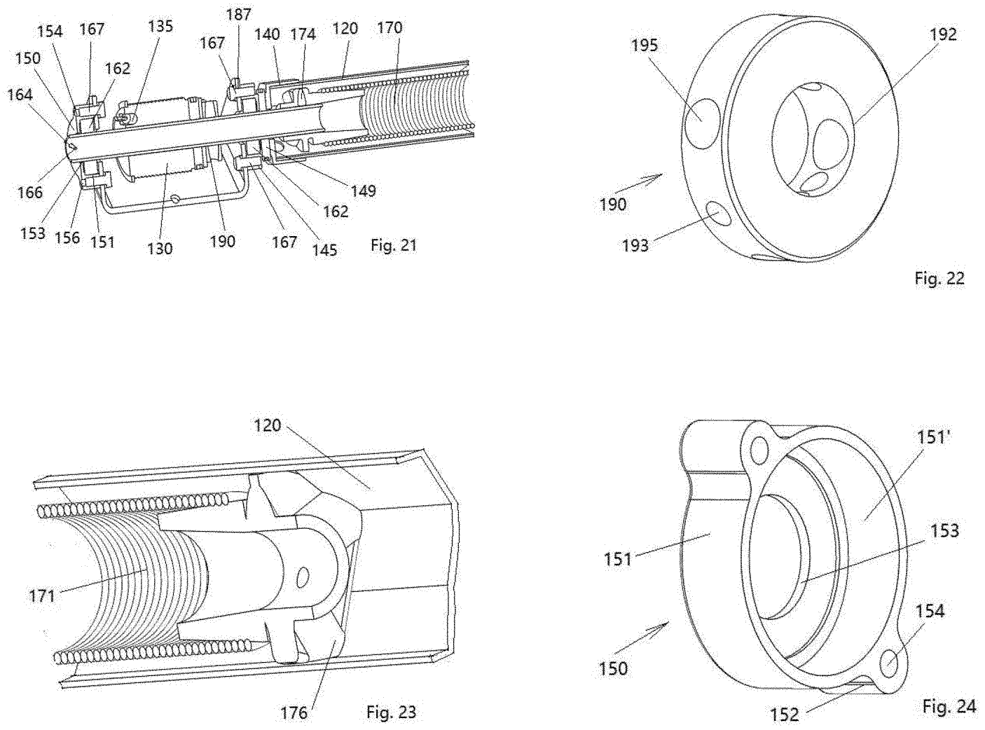

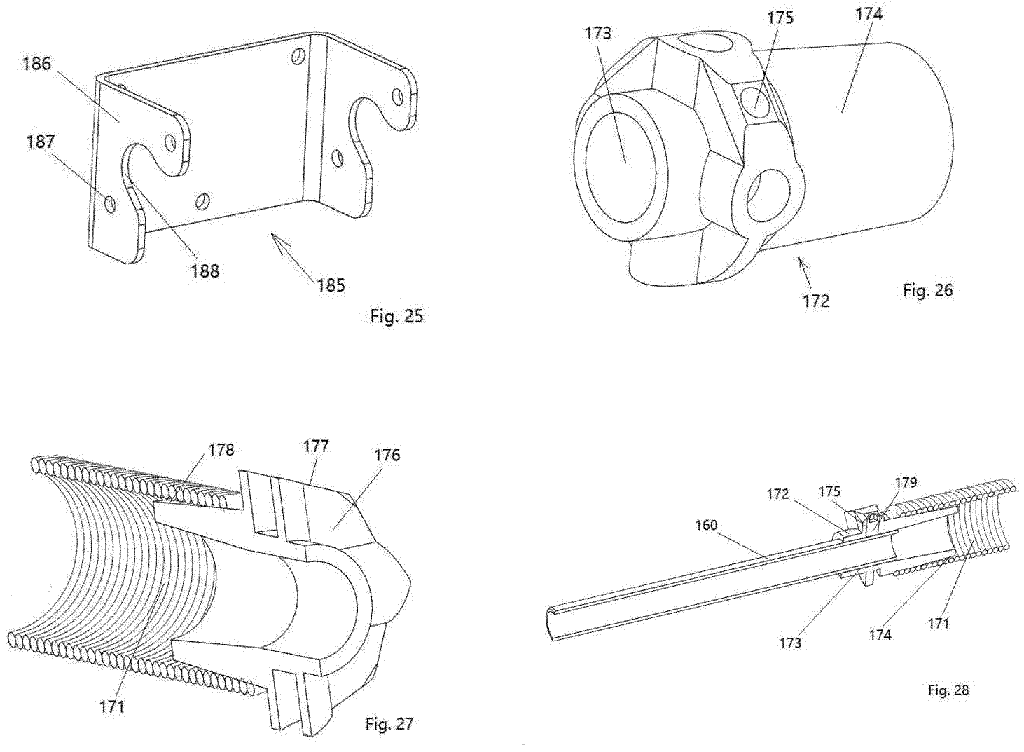

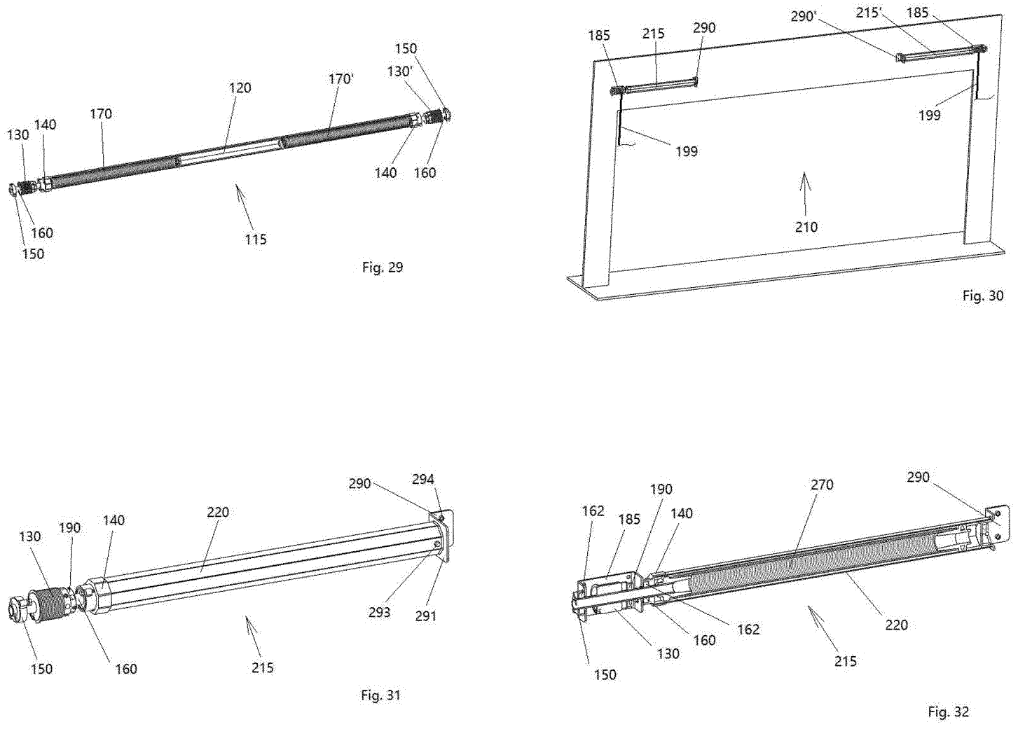

Refer to FIG. 20 and FIG. 21, starting from stationary cone 176, first spring assembly 170 is inserted along −Y direction into octagon pipe 120, with connecting shaft 160 staying outside the end of octagon pipe 120. Then stationary cone 176 is engaged with the internal octagon surface of octagon pipe 120, and it has only one degree of freedom to allow it to move along the center line of octagon pipe 120, with respect to octagon pipe 120 (FIG. 23). Then coupler 140 is received by connecting shaft 160 first, then also received by the first end of octagon pipe 120, with engagement between internal octagon surface of octagon-shaped cup portion 141 and external octagon surface of octagon pipe 120, then a collar 190, first plug 130, and shaft end holder 150 are also received by connecting shaft 160, two bearings 162 are also received by connecting shaft 160 and locates within circular-shaped cup portion 144 of coupler 140, and 150.

The second spring assembly 170′ is symmetrical to first spring assembly 170, and second plug 130′ is symmetrical to first plug 130. They are inserted into octagon pipe 120 along +Y direction from the second end of octagon pipe 120. Other parts, including coupler 140, collar 190, 150 and two bearings 162 are also installed with another connecting shaft 160 too, in the same way as, but symmetrical to described above. After completion of above installation, a counterbalance sub assembly 115 is formed as shown at FIG. 29.

Then counterbalance sub assembly 115 is moved to two U-brackets which has been welded on the truck box as shown at FIG. 17, FIG. 20, and FIG. 21.

Then on each of the inboard ends, a screw 167 passes 187, and is engaged with annex ear 145, while on each of the outboard ends, a screw 167 passes 187 and is engaged with threaded hole 154. Then on each of two connecting shafts 160, a cotter pin 166 engages a hole 164 on the outboard end of connecting shaft 160.

Referring to FIG. 17 and FIG. 21, set screw 194 is tightened against threaded-hole 193, which fixes collar 190 with connecting shaft 160 on each end. Then a conventional torsion bar (not shown) is inserted into winding hole 195 of collar 190 to turn connecting shaft 160 of each end usually in −Y (right hand rule) direction until appropriate torque has been built up with first spring assembly 170 and second spring assembly 170′.

First plug 130 has center through hole 136 whose center line is collinear with the center line of connecting shaft 160. First plug 130 also has external spiral groove 133, and at least one threaded hole 137, and a winding hole 139, both center lines being perpendicular to the center line of connecting shaft 160.

Then the first end fitting 199A (not shown) of a cable 199 is engaged and fixed with engagement slot 135, and its second end fitting 1996 is fixed with a first end of the panel of the door. Then first plug 130 is turned in +Y direction to overcome slack of cable 199, then first plug 130 is fixed with connecting shaft 160 by tightening set screw 138 against threaded hole 137.

Then same procedure is done for the second end, with another cable 199 connecting second plug 130′ and the second end of the panel.

At this time, counterbalance system 110 is ready to work for balancing the weight of the door.

A set screw 149 has the same function as that of set screw 39. Said 149 is engaged with thread hole 143 (FIG. 19 and FIG. 21). When it is fully tightened, the torque energy of first spring assembly 170 is retained within counterbalance system 110 itself, and the cable can be released for maintenance of the door, without losing the power of first spring assembly 170.

The third embodiment of a counterbalance system 210 is shown at FIG. 30 through FIG. 32.

This embodiment is more suitable for an overhead door for dual car garage, which usually has a much longer central shaft in a conventional counterbalance system.

Counterbalance system 210 is very similar to counterbalance system 110. It can be imagined that counterbalance sub assembly 115 in counterbalance system 110 is cut to two halves at the middle of its longitude center line, which means that only the octagon pipe 120 is cut in two halves at the middle of its longitude center line, leading to form the first octagon pipe 220 on the first end, and the second octagon pipe 220′ on the second end.

Usually a stronger first spring assembly 270 replaces the original first spring assembly 170. Then the inboard end of second octagon pipe 220 is engaged with a first inboard bracket 290. First inboard bracket 290 has a vertical portion 291 which has a recession portion whose external surface is received within the internal surface of first octagon pipe 220. They are fixed together by a fastener 293. First inboard bracket 290 generally has two holes 294 on its base portion.

The second counterbalance sub system 215′ is symmetrical to first counterbalance sub system 215, with the second spring assembly 270′ symmetrical to first spring assembly 270, and the second inboard bracket 290′ symmetrical to 290.

FIG. 31 shows the status of 215. Then two U-brackets 185 are fixed with the upper side of the door structure by mechanical means, usually by fasteners. The first U-bracket 185 is fixed at the first, or left end, the second U-bracket 185 at the second, or right end.

Then as shown in FIG. 30 and FIG. 32, the first end of first counterbalance sub system 215 is engaged with the first U-bracket 185 as described in second embodiment, and its second end is fixed with the structure too, through other fasteners and hole 294.

Second counterbalance sub system 215′ is also installed with the structure in symmetrically similar way, on the second end, and usually the center line of second counterbalance sub system 215′ is collinear to that of first counterbalance sub system 215.

Then similar to the second embodiment, the cable 199 connects first plug 130 in first counterbalance sub system 215 and the first end of a door panel, and another cable 199 connects second plug 130′ in the second counterbalance sub system 215′ and the second end of the door panel. This enables counterbalance system 210 to function.

What is claimed is:

1. A counterbalance system for balancing an overhead door installed against a frame structure of a vehicle or a house, said overhead door having at least one door panel, comprising:
a longitude pipe, said longitude pipe having longitude hole with non-circular section cut, said longitude pipe having a first end and a second end;
a first drum and a second drum, said first and second drum each being removably connected on an end of said longitude pipe;
each said first and second drum having a through center hole;
a first pivotal bracket, said first pivotal bracket having a vertical base portion and a longitude tube portion which has usually a circular external surface and a circular internal surface;
a second pivotal bracket, said second pivotal bracket having a vertical base portion and a longitude protrusion portion which has a circular external surface;
said external surface of said first pivotal bracket being engaged pivotally said through center hole of said first drum;
said external surface of said second pivotal bracket being engaged pivotally with said through center hole of said second drum;
a torsion spring assembly; said torsion spring assembly having a first end and a second end;
said torsion spring having a first cone at said first end, and a second cone at said second end;
a connecting shaft having an inboard end and an outboard end,
said second cone having a nor-circular section cut for engaging slidingly with said longitude hole of said longitude pipe;
said first cone having a hole oriented in a longitude direction;
said inboard end of said connecting shaft being engaged with said through center hole of said first cone and being fixedly attached with said first drum;
said outboard end of said connecting shaft having an adjustment means being outwardly exposed outside said first pivotal bracket;
a first cable connecting said first drum and a first end of said door panel; and
a second cable connecting said second drum and a second end of said door panel.

2. The counterbalance system of claim 1, in which said first drum and said second drum each being a cup-shaped drum; each of said first and second drum having a through hole in a bottom side, or an inboard side and an internal surface on an other side, or an outboard side;
said counterbalance system also having two bearings;
each of said bearings having an internal surface and an external surface; said bearing's external surface being engaged with said internal surface of said drum;
said bearing's internal surface being engaged with said shaft; and
said connecting shaft also passing said through center hole of said first drum.

3. A counterbalance system for balancing an overhead door installed against a frame structure of a vehicle or a house, said door having at least one door panel, said system comprising:
a longitude pipe with non-circular section cut;
a pair of U-brackets having two side walls with one center hole on each side;
a pair of torsion spring assemblies received within said pipe, and the inboard end of said assembly being slidingly engaged within said pipe;
a pair of connecting shaft, with inboard side connected with the outboard end of each said spring assembly; said shaft passing said center holes of said U-bracket; the outboard end of each shaft being fixed with the side wall on the outboard end of each said U-bracket; and
a pair of drums each having a center hole received by said shaft, each said drum locating between two side walls of the same U-bracket.

4. A counterbalance system for balancing an overhead door installed against a frame structure of a vehicle or a house, said door having at least one door panel, said system comprising:
a longitude pipe, said pipe having longitude hole with non-circular section cut;
a pair of U-brackets, each of said brackets having two vertical portions, or side walls, each of which has a recessed opening, and at least one hole for fastener connection;
a pair of couplers, each of said couplers having a cup shape structure having a non-circular internal surface and a non-circular external surface, and opening on an inboard end;
each said cup shape structure being connected with each end of said pipe;
each of said couplers also having a bottom on an outboard end, which has a through hole;
each of said couplers also having at least one annex ear with a through hole for connection with said through hole of the inboard side one of said side walls of said U-bracket;
each of said drum having a through center hole;
a pair of torsion springs assemblies; said spring assembly having an outboard end, and an inboard end;
a pair of connecting shafts having an inboard end and an outboard end;
said inboard end of said shaft being fixed with said outboard end of said spring assembly;
a pair of shaft end holders;
each of said connecting shafts also being engaged said through center hole of each said drum then being fixed with each said drum;
each said drum being located between the two side walls of each said U-brackets;
said outboard end of said shaft being fixed with said side wall on the outboard end of said U-bracket through said shaft end holder and fasteners; and
a pair of cables each connecting each of said drums and one end of said door panel on the same side.
